(19) United States
(12) Patent Application Publication
(10) Pub. No.: US 2006/0054381 A1
(43) Pub. Date: Mar. 16, 2006

(54) Exhaust heat recovery muffler

(75) Inventors: Naohiro Takemoto, Aichi (JP); Yoshihiko Suzuki, Aichi (JP)

Correspondence Address: BOURQUE & ASSOCIATES, P.A., 835 HANOVER STREET, SUITE 303, MANCHESTER, NH, 03104, US

(73) Assignee: FUTABA INDUSTRIAL CO., LTD., Oakazaki-shi (JP)

(21) Appl. No.: 11/221,460

(22) Filed: Sep. 8, 2005

(30) Foreign Application Priority Data
Sep. 10, 2004 (JP) 2004-263954
Apr. 20, 2005 (JP) 2005-122595

(51) Int. Cl. F16K 17/00; F01N 1/00; F01N 7/00

(52) U.S. Cl. 181/237; 181/238

(57) ABSTRACT

The exhaust heat recovery muffler includes a muffler unit having the outer surface thereof covered, an exhaust heat recovery unit disposed integrally with the muffler unit, and a switching valve that switches the flow of exhaust gas into the muffler unit and into the exhaust heat recovery unit. An outer pipe of the muffler unit and a cylindrical shell of the exhaust heat recovery unit, covering the outer circumference of the outer pipe, are coaxially disposed. The exhaust heat recovery unit includes a heat exchange chamber, formed by a pair of partitions provided between the inner circumference of the shell and the outer circumference of the outer pipe, and small-diameter pipes penetrating through the pair of partitions and extending through the heat exchange chamber. A heat exchange medium flows inside of the heat exchange chamber.

### BACKGROUND OF THE INVENTION

(1) Field of the Invention

The present invention relates to an exhaust heat recovery muffler that conducts a heat exchange between exhaust gas and a heat exchange medium, a recovery of exhaust heat, as well as a noise reduction.

(2) Background Art

A conventional exhaust heat recovering device is disposed in an exhaust path, and provided with a muffler, having an inner pipe with several small openings and an outer pipe covering the inner pipe, and a heat exchanger disposed inside of the inner pipe to recover heat from the exhaust gas (cf. Unexamined Japanese Patent Publication No. 2000-204941). The heat exchanger is constituted with a pair of plates, which form a path for coolant water, and an inner fin, alternately layered. This conventional device reduces exhaust noise with the muffler and recovers exhaust heat with the heat exchanger.

Another conventional exhaust beat recovery device has an exhaust heat recovery unit that is provided in an exhaust path and exchanges heat between the exhaust gas from an internal combustion engine and a heat exchange medium, such as coolant water, as disclosed in Unexamined Japanese Patent Publication No. 2004-246128. This exhaust heat recovery device is provided with a plurality of small exhaust pipes inside of an external cylinder. Heat exchange is conducted between the exhaust gas, which goes through the small exhaust pipes, and coolant water that flows outside of the small exhaust pipes. The exhaust heat recovery device is also provided with an exhaust path outside of the small exhaust pipes and a control valve, which allows and blocks the flow of exhaust gas, in order to switch the flow of exhaust gas corresponding to the operation status of the internal combustion engine.

### SUMMARY OF THE INVENTION

The exhaust path of an internal combustion engine provided in an automobile is generally disposed under the floor of an automobile and is also provided with other devices, such as a catalytic converter, a sub-muffler, and a main muffler. There are concaves and convexes under the floor because of the fuel tank and other equipment. In some cases, axles are also provided therein. Therefore, the space to dispose devices under the floor of an automobile is limited.

It is difficult to provide sufficient space for the conventional exhaust gas heat recovering device disclosed in JP 2000-204941, because the structure thereof is complicated and the size of the device is large, due to the heat exchanger disposed inside of the inner pipe.

It is even more difficult to provide sufficient space for the conventional exhaust heat recovery device disclosed in JP 2004-245128, because the above-described exhaust heat recovery unit needs to be disposed in that space along with a sub-muffler and a main muffler.

To solve the above and other issues, it is one of the purposes of the present invention to provide a compact exhaust heat recovery muffler with a simple structure.

In order to attain this and other objects, the present invention provides an exhaust heat recovery muffler which comprises: a muffler unit that modifies an exhaust noise and includes an outer pipe, an exhaust heat recovery unit that exchanges heat between an exhaust gas and a heat exchange medium and includes a substantially cylindrical outer shell, and a switching valve that switches a flow of the exhaust gas between the muffler unit and the exhaust heat recover unit. The exhaust heat recovery unit is integrally disposed with the muffler unit, and the outer shell covers an outer circumference of the outer pipe.

The exhaust heat recovery muffler may have a structure wherein an outer pipe of the muffler unit is disposed coaxially with a cylindrical shell of the exhaust heat recovery unit, which covers the outer circumference of the outer pipe. The exhaust heat recovery unit may be provided with a heat exchange chamber, which is formed with a pair of partitions disposed between the inner circumference of the shell and the outer circumference of the outer pipe, and small-diameter pipes, which penetrate the pair of partitions and pass through and within the heat exchange chamber. The heat exchange medium may be circulated in the heat exchange chamber. Alternatively, the exhaust heat recovery unit may be provided with a cylindrical outer jacket, disposed between the inner circumference of the shell and the outer circumference of the outer pipe so that both ends of the outer jacket are sealed onto the inner circumference of the shell, so as to form a path for the heat exchange medium between the inner circumference of the shell and the outer circumference of the outer jacket. The exhaust heat recovery unit may also be provided with a cylindrical inner jacket, having both ends sealed onto the outer circumference of the outer pipe, so as to form a path for the heat exchange medium between the outer circumference of the outer pipe and the inner circumference of the inner jacket, and to form an exhaust passageway between the inner circumference of the outer jacket and the outer circumference of the inner jacket. In this case, both paths for the heat exchange medium may communicate with each other through a through-hole that is formed at various locations wherein one portion of the inner circumference of the outer jacket and one portion of the outer circumference of the inner jacket are in contact with each other. The outer and the inner jackets may be formed in such a manner that the sections of the jackets perpendicular to the longitudinal direction of the jackets are corrugated and that the surface areas of the jackets are increased.

The muffler unit may be provided with an inner pipe, wherein the exhaust gas passes through, and an outer pipe that covers the outside of the inner pipe. The inner pipe may have several small openings that communicate with the area inside of the outer pipe. Moreover, the switching valve may be constituted to block the flow of the exhaust gas into the muffler unit and to switch the flow of the exhaust gas from into the muffler unit to into the exhaust heat recovery unit.

The exhaust heat recovery muffler of the present invention comprises a muffler unit, having the outer surface thereof covered, and an exhaust heat recovery unit disposed integrally with the muffler unit. The exhaust heat recovery muffler furthermore comprises a switching valve that switches the flow of exhaust gas into the muffler unit and into the exhaust heat recovery unit. Hence, according to the present invention, the structure of the exhaust heat recovery muffler can be simple and compact. The exhaust heat recovery muffler of one aspect of the present invention is provided with a heat exchange chamber, which is formed by partitions and small-diameter pipes that extend through the heat exchange chamber. According to one aspect of the present invention, the structure of the exhaust heat recovery muffler can be simple and compact, and the cross-section area of a path in the exhaust heat recovery unit, wherein exhaust gas passes through, can be maintained to be sufficiently large. The exhaust heat recovery muffler of another aspect of the present invention is provided with an outer jacket and an inner jacket. According to another aspect of the present invention, the structure of the exhaust heat recovery muffler can be simple and compact, and the manufacturing thereof can be simplified.

### BRIEF DESCRIPTION OF THE DRAWINGS

The invention will now be described below, by way of example, with reference to the accompanying drawings.

FIG. 1 is a sectional view to show the structure of the exhaust heat recovery muffler of the first embodiment according to the present invention;

FIG. 2 is a sectional view taken along line II-II in FIG. 1;

FIG. 3 is a sectional view to show the structure of the exhaust heat recovery muffler of the second embodiment;

FIG. 4 is an enlarged sectional view taken along line IV-IV in FIG. 3;

FIG. 5 is a sectional view to show the structure of the exhaust heat recovery muffler of the third embodiment;

FIG. 6 is an enlarged sectional view taken along line VI-VI in FIG. 5;

FIG. 7 is a sectional view to show the structure of the exhaust heat recovery muffler of the fourth embodiment; and

FIG. 8 is an enlarged sectional view taken along line VIII-VIII in FIG. 7.

### DETAILED DESCRIPTION OF THE PREFERRED EMBODIMENT

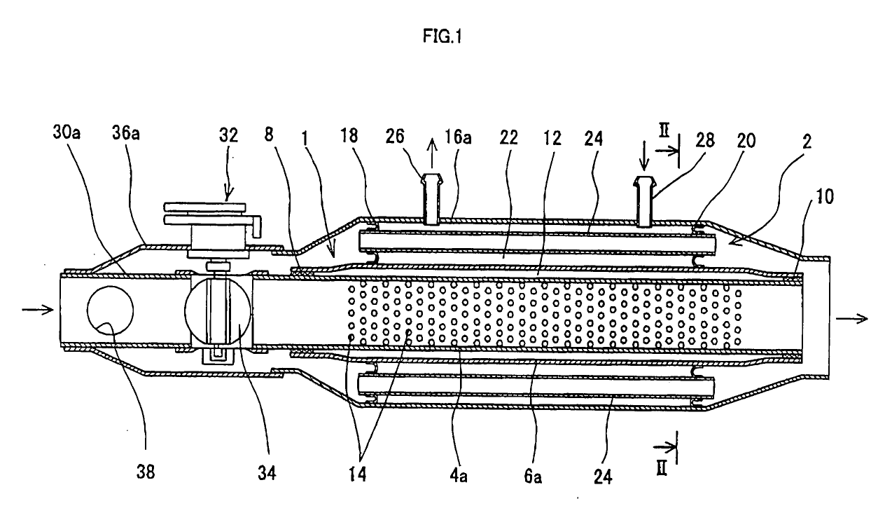

Referring to FIG. 1, reference numeral 1 indicates a muffler unit and reference numeral 2 indicates an exhaust heat recovery unit. The muffler unit 1 comprises an inner pipe 4a and an outer pipe 6a. The inner pipe 4a is inserted into the outer pipe 6a so as to be concentric with the outer pipe 6a. The diameters of both ends of the outer pipe 6a are contracted, and wire meshes 8 and 10 are provided between the inner circumference of the both ends of the outer pipe 6a and the outer circumference of the inner pipe 4a. A silencing chamber 12 is formed between the inner circumference of the outer pipe 6a and the outer circumference of the inner pipe 4a. Multiple small openings 14 are provided on the inner pipe 4a and communicate with the inside of the outer pipe 6a.

The exhaust heat recovery unit 2 comprises a shell 16a that covers the outer circumference of the outer pipe 6a of the muffler unit 1. The shell 16a is cylindrical and provided coaxially with the outer pipe 6a. Between the outer circumference of the outer pipe 6a and the inner circumference of the shell 16a, a pair of partitions 18 and 20 is disposed at predetermined intervals, and heat exchange chambers 22 are formed therein.

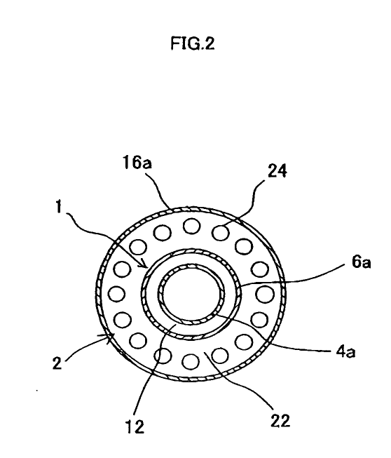

Multiple small-diameter pipes 24 are provided in the heat exchange chamber 22 and protrude from the pair of partitions 18 and 20. As shown in FIG. 2, the small-diameter pipes 24 are provided along the outer circumference of the outer pipe 6a so as to be concentric with the outer pipe 6a. Both ends of the small-diameter pipes 24 are opened and disposed outside of the heat exchange chamber 22 between the outer circumference of the outer pipe 6a and the inner circumference of the shell 16a.

One pair of joint members 26 and 28, connected to the heat exchange chamber 22, is attached to the shell 16a. Supplying and discharging of the heat exchange medium to/from the heat exchange chamber 22 is conducted through this pair of joint members 26 and 28. In the present embodiment, coolant water from an internal combustion engine (not shown) is used as the heat exchange medium. The diameters of both ends of the shell 16a are contracted. There are gaps formed in the vicinity of the both ends of the shell 16a between the inner circumference of the shell 16a and the outer circumference of the outer pipe 6a. Exhaust gas can pass through these gaps.

In the upstream side of the inner pipe 4a a connection pipe 30a is coaxially provided having a diameter almost equal to the diameter of the inner pipe 4a. The connection pipe 30a and the inner pipe 4a are connected with a switching valve 32. The switching valve 32 of the present embodiment is a butterfly valve. The switching valve 32 connects/blocks the connection pipe 30a and the inner pipe 4a by pivoting a valve plug 34. The switching valve 32 may drive the valve plug 34 by using the negative pressure of the supplied air in the internal combustion engine. Alternatively, the switching valve 32 may drive the valve plug 34 with an electric motor.

The connection pipe 30a is inserted into a linking pipe 36a. The diameter of one end of the linking pipe 36a on the upstream side is contracted and sealed onto the outer circumference of the connection pipe 30a. The other end of the linking pipe 36a receives the outer circumference of the shell 16a and is sealed thereto. A pair of communication holes 38 (only one of them is shown in the drawing) is provided on the connection pipe 30a. The interior of the connection pipe 30a and the interior of the linking pipe 36a are communicated with each other through the pair of communication holes 38. The connection pipe 30a is connected to the upstream side of an exhaust path to which the exhaust heat recovery muffler of the present embodiment is connected. The shell 16a is connected to the downstream side of the exhaust path.

The following describes the operation of the exhaust heat recovery muffler of the present embodiment.

Firstly, the valve plug 34 of the switching valve 32 is driven so that the connection pipe 30a and the inner pipe 4a are communicated with each other, as shown in FIG. 1. When exhaust gas from an internal combustion engine (not shown) flows into the connection pipe 30a, the exhaust gas goes into the inner pipe 4a via the switching valve 32. Although the connection pipe 30a is provided with the communication holes 38, most of the exhaust gas flows into the inner pipe 4a because the inlet resistance into the inner pipe 4a is small. The noise of the exhaust gas, which passes through the inner pipe 4a, is reduced by the muffler unit 1 with the interference effect between the effect of the several small openings 14 and the effect of the silencing chamber 12.

When the valve plug 34 of the switching valve 32 is driven so that the connection pipe 30a and the inner pipe 4a are blocked, exhaust gas flows into the linking pipe 36a through the communication holes 38. Subsequently, the exhaust gas flows from the linking pipe 36a into the gaps, provided between the shell 16a and the outer pipe 6a, and flows into the small-diameter pipes 24. The exhaust gas, which passes through the small-diameter pipes 24, goes out to the exhaust path in the downstream side of the exhaust heat recovery muffler through the gaps provided between the shell 16a and the outer pipe 6a.

The heat exchange medium, which is coolant water provided from the internal combustion engine, is supplied via the joint member 28 into the heat exchange chamber 22 and discharged from another joint member 26. While the heat exchange medium is in the heat exchange chamber 22, heat exchange is conducted between the heat exchange medium and the exhaust gas through the small-diameter pipes 24. Since the temperature of the exhaust gas is higher than the temperature of the heat exchange medium, the temperature of the heat exchange medium increases and the temperature of the exhaust gas decreases. In this manner, heat exchange between the exhaust gas and the heat exchange medium is conducted by the exhaust heat recovery unit 2 and exhaust heat is recovered.

If the driving of the switching valve 32 is controlled by a control circuit (not shown) corresponding to the operational status of the internal combustion engine, the fuel consumption of the internal combustion engine can be improved. For example, if the switching valve 32 blocks the connection pipe 30a and the inner pipe 4a and the exhaust heat recovery unit 2 conducts heat exchange between the exhaust gas and the heat exchange medium when the temperature of the coolant water is low, such as immediately after the internal combustion engine initiates operation, the temperature of the coolant water, i.e. the heat exchange medium, promptly increases. Therefore, the fuel consumption of the internal combustion engine improves.

As described above, the exhaust heat recovery muffler of the present embodiment comprises a muffler unit 1 having the outer surface thereof covered, an exhaust heat recovery unit 2 disposed integrally with the muffler unit 1, and a switching valve 32 that switches the flow of exhaust gas into the muffler unit 1 and into the exhaust heat recovery unit 2. Consequently, the structure of the exhaust heat recovery muffler has become simple and compact. The exhaust heat recovery muffler of the present embodiment furthermore comprises a heat exchange chamber 22 formed by the partitions 18 and 20, and the small-diameter pipes 24 provided outside of the outer pipe 6a so as to be penetrating through the heat exchange chamber 22. Therefore, the cross-sectional area of the path in the exhaust heat recovery unit 2, wherein the exhaust gas passes through, is maintained to be sufficiently large.

### Second Embodiment

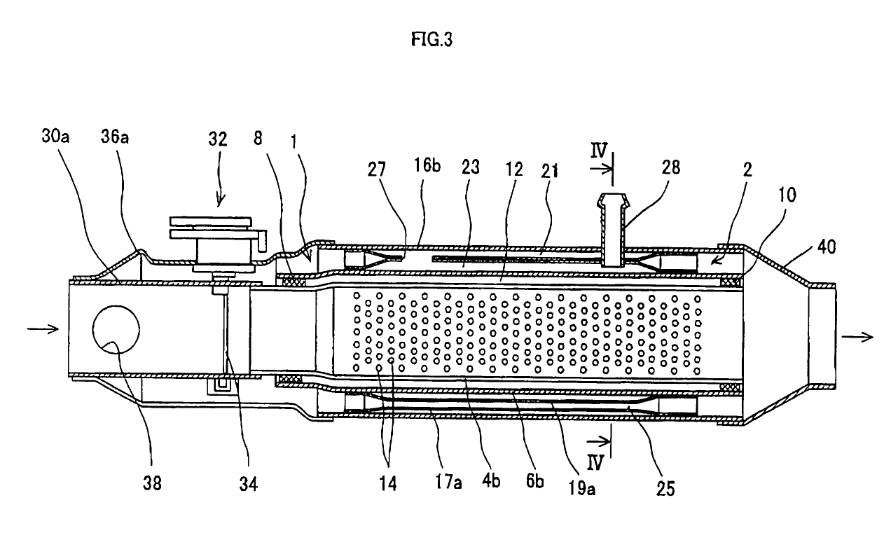

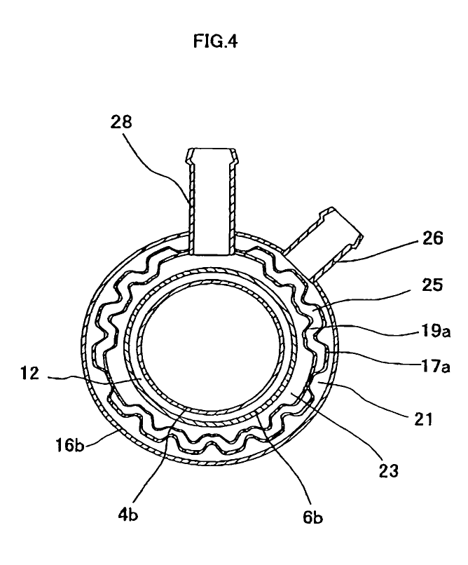

Referring now to FIGS. 3 and 4, the following describes a second embodiment of the present invention.

As shown in FIG. 3, reference numeral 1 indicates a muffler unit. Reference numeral 2 indicates an exhaust heat recovery unit. The muffler unit 1 comprises an inner pipe 4b and an outer pipe 6b. The inner pipe 4b is inserted into the outer pipe 6b so as to be disposed coaxially with the outer pipe 6b. Wire meshes 8 and 10 are provided on both ends of the outer pipe 6b between the inner circumference of the outer pipe 1b and the outer circumference of the inner pipe 4b. A silencing chamber 12 is formed between the inner circumference of the outer pipe 6b and the outer circumference of the inner pipe 4b. Multiple small openings 14 are provided on the inner pipe 4b so as to be communicated with the silencing chambers 12.

The exhaust heat recovery unit 2 comprises a shell 16b that covers the outer circumference of the outer pipe 6b of the muffler unit 1. The shell 16b is cylindrical and provided coaxially with the outer pipe 6b. Between the outer circumference of the outer pipe 6b and the inner circumference of the shell 16b, a cylindrical outer jacket 17a and a cylindrical inner jacket 19a are provided to be respectively coaxial with the shell 16b.

The diameters of both ends of the outer jacket 17a are respectively enlarged toward the outside in the radial direction. The outer circumference of the outer jacket 17a is sealed onto the inner circumference of the shell 16b. Consequently, an outer path 21 for coolant water is formed between the inner circumference of the shell 16b and the outer circumference of the outer jacket 17a.

The diameters of both ends of the inner jacket 19a are respectively contracted toward the inside in the radial direction. The inner circumference of the inner jacket 19a is sealed onto the outer circumference of the outer pipe 6b. Consequently, an inner path 23 for coolant water is formed between the outer circumference of the outer pipe 6b and the inner circumference of the inner jacket 19a.

As shown in FIG. 4, an exhaust passageway 25 is formed between the inner circumference of the outer jacket 17a and the outer circumference of the inner jacket 19a. Both ends of the exhaust passageway 25 communicate with the gap between the outer circumference of the outer pipe 6b and the inner circumference of the shell 16b.

The cross-sectional surfaces of the outer jacket 17a and the inner jacket 19a, which are respectively orthogonal to the longitudinal direction of the outer and inner jackets 17a and 19a, are corrugated so as to increase the superficial dimensions. There are three points in the circumferential direction of the jackets 17a and 19a wherein one portion of the inner circumference of the outer jacket 17a and one portion of the outer circumference of the inner jacket 19a are in contact with each other. The exhaust passageway 25 is divided into three portions at these points. A through-hole 27 is formed in one part of the contact portion of the inner circumference of the outer jacket 17a and the outer circumference of the inner jacket 19a. The outer path 21 and inner path 23 for coolant water communicate through the through-hole 27.

One pair of joint members 26 and 28 is attached to the shell 16b. The joint member 26 penetrates through the shell 16b and is connected to the outer path 21. The other joint member 28 penetrates through the shell 16b, the outer and the inner jackets 17a and 19a, and is connected to the inner path 23. The heat exchange medium is supplied/discharged to/from the outer and inner path 21 and 23 through the pair of the joint members 26 and 28. In the present embodiment, coolant water of an internal combustion engine (not shown) is used as the heat exchange medium.

In the upstream side of the inner pipe 4b, a connection pipe 30b, having the diameter almost equal to the diameter of the inner pipe 4b, is coaxially provided. The end of the inner pipe 4b in the upstream side is contracted and inserted into the connection pipe 30b. A switching valve 32 is provided in the connection pipe 30b. In the present embodiment, the switching valve 32 is a butterfly valve and is constituted to be able to connect/block the connection pipe 30b and the inner pipe 4b. The switching valve 32 may drive a valve plug 34 by using the negative pressure of the supplied air in the internal combustion engine. The switching valve 32 may also drive the valve plug 34 with an electric motor.

The connection pipe 30b is inserted into a linking pipe 36b. The diameter of one end of the linking pipe 36b on the upstream side is contracted and sealed onto the outer circumference of the connection pipe 30b. The other end of the linking pipe 36b on the downstream side receives the outer circumference of the shell 16b and is sealed thereto. A pair of communication holes 38 (only one of them is shown in the drawing) is provided on the connection pipe 30b. The interior of the connection pipe 30b and the interior of the linking pipe 36b are communicated with each other through the pair of communication holes 38.

The downstream side of the shell 16b is inserted into a linking pipe 40. One end of the linking pipe 40 on the downstream side is tapered and the inner diameter thereof is almost equal to the outer diameter of the inner pipe 4b.

The downstream end of the inner pipe 4b is configured so as to be aligned with the downstream end of the shell 16b. The inner pipe 4b is open toward the inside of the linking pipe 40. The connection pipe 30 is connected to an exhaust path on the upstream side of the muffler. The linking pipe 40 is connected to the exhaust path on the downstream side of the muffler.

The following describes the operation of the exhaust heat recovery muffler with the constitution described above according to the second embodiment.

Firstly, the valve plug 34 of the switching valve 32 is driven so that the connection pipe 30b and the inner pipe 4b are communicated with each other. When exhaust gas from an internal combustion engine (not shown) flows into the connection pipe 30b, the exhaust gas goes into the inner pipe 4b via the switching valve 32. Although the connection pipe 30b is provided with the communication holes 38, most of the exhaust gas flows into the inner pipe 4b because the inlet resistance into the inner pipe 4b is small. The noise of the exhaust gas, which passes through the inner pipe 4b, is reduced by the muffler unit 1 with the interference effect between the multiple small openings 14 and the effect of the silencing chamber 12.

When the valve plug 34 of the switching valve 32 is driven so that the connection pipe 30b and the inner pipe 4b are blocked, exhaust gas flows into the linking pipe 36b through the communication holes 38. Subsequently, the exhaust gas flows from the linking pipe 36b into a gap between the shell 16b and the outer pipe 6b, and then flows from the gap into the exhaust passageway 25 provided between the outer jacket 17a and the inner jacket 19a. The exhaust gas, which has passed through the exhaust passageway 25, flows from the gap between the shell 16b and the outer pipe 6b into the linking pipe 40. The exhaust gas furthermore flows into an exhaust path on the downstream side of the muffler.

The heat exchange medium, which is coolant water from the internal combustion engine, is supplied from the joint member 28 into the inner path 23. The heat exchange medium flows out to the outer path 21 through the through-hole 27, and is discharged from the other joint member 26 through the outer path 21. While the heat exchange medium is flowing through the above-described route, heat exchange is conducted between the heat exchange medium inside of the inner and the outer paths 23 and 21 and the exhaust gas, which flows in the exhaust passageway 25, through the inner and the outer jackets 19a and 17a.

Since the temperature of the exhaust gas is higher than the temperature of the heat exchange medium, the temperature of the heat exchange medium increases and the temperature of the exhaust gas decreases. Accordingly, the exhaust heat recovery unit 2 conducts heat exchange between the exhaust gas and the heat exchange medium and recovers exhaust heat.

As described above, the exhaust heat recovery muffler of the present embodiment comprises a muffler unit 1 having the outer surface thereof covered, an exhaust heat recovery unit 2 disposed integrally with the muffler unit 1, and a switching valve 32 that switches the flow of exhaust gas into the muffler unit 1 and into the exhaust heat recovery unit 2. Consequently, the structure of the exhaust heat recovery muffler has become simple and compact. The exhaust heat recovery muffler of the present embodiment furthermore comprises an outer and an inner jackets 17a and 19a that separate the paths 21 and 23 for the coolant water from the exhaust passageway 25. This structure simplifies the formation of the outer and inner jackets 17a and 19a. This structure also simplifies the assembly and manufacture of the exhaust heat recovery muffler of the present embodiment.

### Third Embodiment

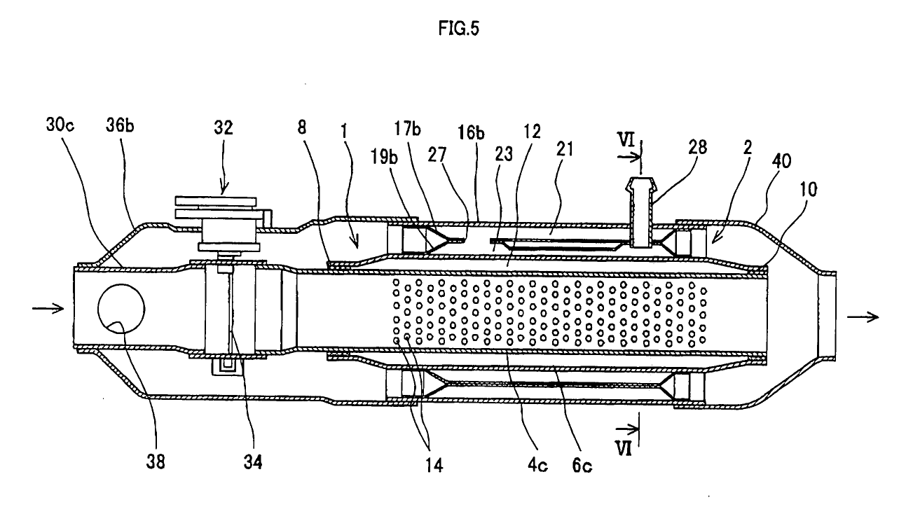

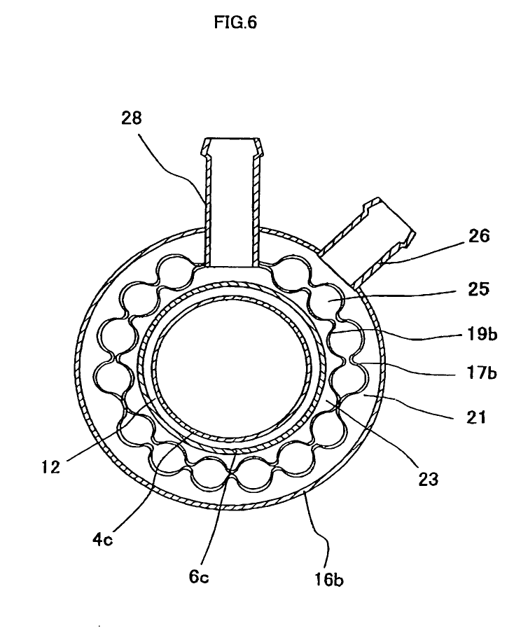

Referring now to FIGS. 5 and 6, the following describes a third embodiment of the present invention. The basic structure of the exhaust heat recovery muffler according to the present embodiment is the same as the structure of the exhaust heat recovery muffler according to the second embodiment. The same reference numerals are given to the same constituents as in the above-described second embodiment. Detailed description of these constituents is not repeated herein. The same applies to the following embodiment.

As shown in FIG. 5, both ends of an outer pipe 6c are tapered. Wire meshes 8 and 10 are provided between the inner circumference of the outer pipe 6c and the outer circumference of an inner pipe 4c. A silencing chamber 12 is formed between the inner circumference of the outer pipe 6c and the outer circumference of the inner pipe 4c.

In an exhaust heat recovery unit 2, a cylindrical outer jacket 17b and a cylindrical inner jacket 19b are provided between the outer circumference of the outer pipe 6c and the inner circumference of the shell 16b so as to be coaxial with the shell 16b.

As shown in FIG. 6, the cross-sectional surface of the outer and the inner jackets 17b and 19b, perpendicular to the longitudinal direction of the jackets 17b and 19b, are corrugated so as to increase the surface area thereof. In the present embodiment, the outer jacket 17b is corrugated so as to be protruding outward in the shape of semicircular arcs. The inner jacket 19b is corrugated so as to be recessed inward in the shape of semicircular arcs. The two jackets 17b and 19b form the exhaust passageway 25 in an almost cylindrical shape. Some portions of the inner circumference of the outer jacket 17b and some portions of the inner jacket 19b are in contact with each other at three points in the circumferential direction thereof.

On the upstream side of the inner pipe 4c, a connection pipe 30c, having a diameter almost equal to the diameter of the inner pipe 4c, is provided so as to be coaxial with the inner pipe 4c. The diameter of the upstream side of the inner pipe 4c and the diameter of the downstream side of the connection pipe 30c are enlarged and connected via a switching valve 32.

The connection pipe 30c is inserted into a linking pipe 36b. The diameter of the upstream end of the linking pipe 36b is contracted and sealed onto the outer circumference of the connection pipe 30c. The downstream side of the shell 16b is inserted into a linking pipe 40 and connected thereto. The linking pipe 40 is tapered on the downstream side thereof.

The following describes the operation of the exhaust heat recovery muffler with the constitution described above according to the third embodiment.

In the same manner as in the second embodiment, when the valve plug 34 of the switching valve 32 is driven so that the connection pipe 30c and the inner pipe 4c are blocked, as shown in FIG. 5, the exhaust gas flows into the linking pipe 36b through the communication holes 38. Subsequently, the exhaust gas flows from the linking pipe 36b into a gap between the shell 16b and the outer pipe 6c, and then flows from this gap into the exhaust passageway 25 provided between the outer jacket 17b and the inner jacket 19b. The exhaust gas, which has been through the exhaust passageway 25, flows from the gap between the shell 16b and the outer pipe 6c into the linking pipe 40. Furthermore, the exhaust gas flows out into an exhaust path provided on the downstream side of the exhaust heat recovery muffler.

While the exhaust gas goes through the above-described route, a heat exchange is conducted between the heat exchange medium, within the inner and outer paths 23 and 21, and the exhaust gas, which goes through the exhaust passageway 25, through the inner and the outer jackets 19b and 17b.

As described above, the exhaust heat recovery muffler of the present embodiment comprises a muffler unit 1 having the outer surface thereof covered, an exhaust heat recovery unit 2 disposed integrally with the muffler unit 1, and a switching valve 32 that switches the flow of exhaust gas into the muffler unit 1 and into the exhaust heat recovery unit 2. Therefore, the structure of the exhaust heat recovery muffler of the present embodiment has become simple and compact. Moreover, since the outer and inner jackets 17b and 19b separate the outer and inner paths 21 and 23 from the exhaust passageway 25, the formation of the outer and inner jackets 17b and 19b, the assembly and the manufacturing of the exhaust heat recovery muffler are simplified.

### Fourth Embodiment

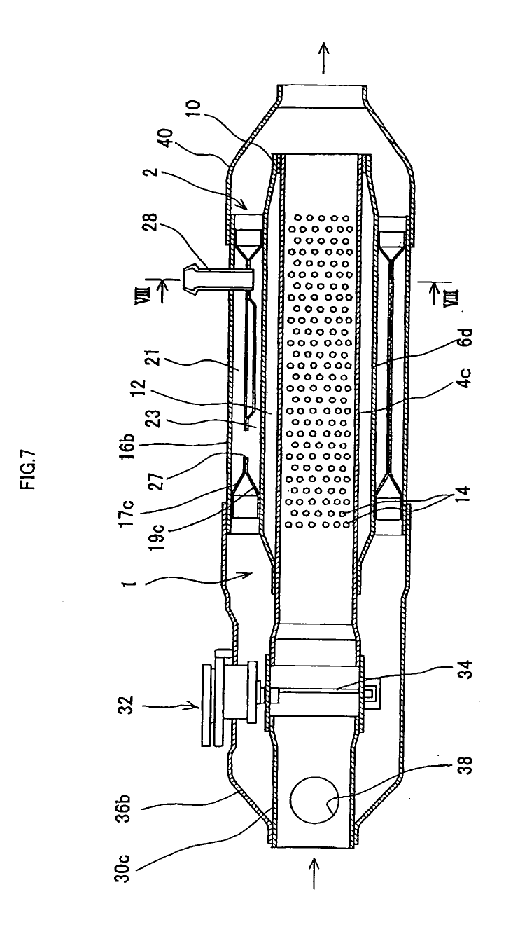

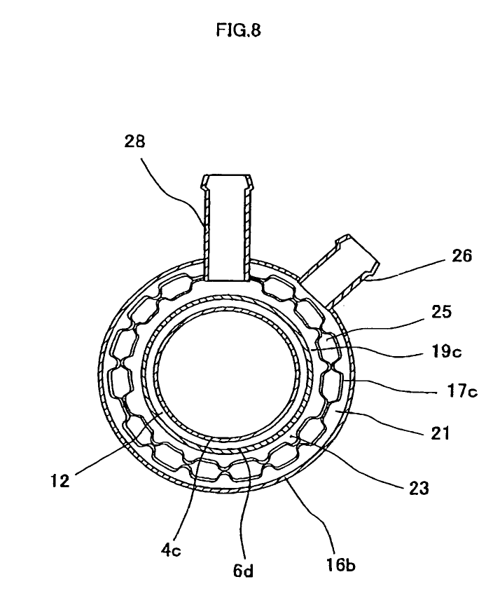

Referring now to FIGS. 7 and 8, the following describes a fourth embodiment of the present invention.

As shown in FIG. 7, the upstream side of an outer pipe 6d is tapered, and the inner circumference thereof is sealed onto the outer circumference of the inner pipe 4c. The downstream side of the outer pipe 6d is also tapered. However, a wire mesh 10 is provided between the inner circumference of the outer pipe 6d on the downstream side and the outer circumference of the inner pipe 4c. A silencing chamber 12 is formed between the inner circumference of the outer pipe 6d and the outer circumference of the inner pipe 4c.

In an exhaust heat recovery unit 2, a cylindrical outer jacket 17c and a cylindrical inner jacket 19c are provided between the outer circumference of the outer pipe 6d and the inner circumference of the shell 16b so as to be respectively coaxial with the shell 16b.

As shown in FIG. 8, the cross-sectional surface of the outer and the inner jackets 17c and 19c, perpendicular to the longitudinal direction of the jackets 17c and 19c, are corrugated so as to increase the surface area thereof. In the present embodiment, the outer jacket 17c is corrugated so as to be protruding outward in rectangular shapes. The inner jacket 19c is corrugated so as to be recessed inward in rectangular shapes. The two jackets 17c and 19c form the exhaust passageway 25 in an almost prismatic shape. Some portions of the inner circumference of the outer jacket 17c and some portions of the inner jacket 19c are in contact with each other at three points in the circumferential direction thereof. The rest of the structure of the exhaust heat recovery muffler according to the present embodiment is the same as in the above-described third embodiment.

In the same manner as in the second embodiment, when the valve plug 34 of the switching valve 32 is driven so as to block the connection pipe 30c and the inner pipe 4c, as shown in FIG. 7, the exhaust gas flows into a linking pipe 36b through the communication holes 38. Subsequently, the exhaust gas flows from the linking pipe 36b into a gap between the shell 16b and the outer pipe 6d. The exhaust gas furthermore flows from the gap into the exhaust passageway 25 provided between the outer jacket 17c and the inner jacket 19c. The exhaust gas that has been through the exhaust passageway 25 flows from the gap between the shell 16b and the outer pipe 6d into the linking pipe 40, and then flows out to an exhaust path provided on the downstream side of the exhaust heat recovery muffler.

While the exhaust gas goes through the above-described route, heat exchange is conducted between the heat exchange medium, which is in the inner and the outer paths 23 and 21, and the exhaust gas, which passes through the exhaust passageway 25, through the inner and the outer jackets 19c and 17c.

As described above, the exhaust heat recovery muffler of the present embodiment comprises a muffler unit 1 having the outer surface thereof covered, the exhaust heat recovery unit 2 disposed integrally with the muffler unit 1, and a switching valve 32 that switches the flow of exhaust gas into the muffler unit 1 and into the exhaust heat recovery unit 2. Therefore, the structure of the exhaust heat recovery muffler of the present embodiment has become simple and compact. Moreover, since the outer and inner jackets 17c and 19c separate the outer and inner paths 21 and 23 from the exhaust passageway 25, the formation of the outer and inner jackets 17c and 19c, the assembly, and the manufacturing of the exhaust heat recovery muffler are simplified.

The present invention is not limited to the above-described embodiments. Variations and modifications are possible within the scope of the invention.

What is claimed is:

1. An exhaust heat recovery muffler comprising:
a muffler unit that modifies an exhaust noise and includes an outer pipe, and
an exhaust heat recovery unit that exchanges heat between an exhaust gas and a heat exchange medium and includes a substantially cylindrical outer shell, and
a switching valve that switches a flow of the exhaust gas between the muffler unit and the exhaust heat recover unit, wherein:
the exhaust heat recovery unit is integrally disposed with the muffler unit, and
the outer shell covers an outer circumference of the outer pipe.

2. The exhaust heat recovery muffler as set forth in claim 1, wherein:
the exhaust heat recovery unit further comprises:
a pair of partitions provided between an inner circumference of the outer shell and an outer circumference of the outer pipe;
a heat exchange chamber bounded by the pair of partitions, the inner circumference of the outer shell, and the outer circumference of the outer pipe;
a plurality of small-diameter pipes that penetrate through the pair of partitions and extend through the heat exchange chamber, and wherein:
the heat exchange medium flows through the heat exchange chamber,
the exhaust gas flows through the plurality of small diameter pipes.

3. The exhaust heat recovery muffler as set forth in claim 2, wherein:
the muffler unit further comprises:
an inner pipe wherein the exhaust gas passes through;
the outer pipe substantially covers an outer circumference of the inner pipe,
a plurality of inner pipe orifices communicate with a volume bounded by the outer pipe and the inner pipe.

4. The exhaust heat recovery muffler as set forth in claim 1, wherein:
the exhaust heat recovery unit further comprises:
a substantially cylindrical outer jacket provided between an inner circumference of the outer shell and an outer circumference of the outer pipe, defining a first volume bounded by the outer jacket and the inner circumference of the outer shell,
a substantially cylindrical inner jacket defining a second volume bounded by the inner jacket and the outer circumference of the outer pipe;
an exhaust gas passageway formed between an inner circumference of the outer jacket and an outer circumference of the inner jacket;
a heat exchange medium passageway formed by at least one of a group consisting of the first volume and the second volume.

5. The exhaust heat recovery muffler as set forth in claim 4, wherein:
the exhaust heat recovery unit further comprises:
at least one communication orifice between the first volume and the second volume, and
the heat exchange medium passageway further includes the at least one communication orifice.

6. The exhaust heat recovery muffler as set forth in claim 5, wherein;
at least one of the group consisting of the inner jacket and the outer jacket has a corrugated cross-sectional surface perpendicular to a longitudinal direction thereof.

7. The exhaust heat recovery muffler as set forth in claim 6, wherein:
the muffler unit further comprises:
an inner pipe wherein the exhaust gas passes through;
the outer pipe substantially covers an outer circumference of the inner pipe,
a plurality of inner pipe orifices communicate with a volume bounded by the outer pipe and the inner pipe.

8. The exhaust heat recovery muffler as set forth in claim 4, wherein;
at least one of the group consisting of the inner jacket and the outer jacket has a corrugated cross-sectional surface perpendicular to a longitudinal direction thereof.

9. The exhaust heat recovery muffler as set forth in claim 8, wherein:
the muffler unit further comprises:
an inner pipe wherein the exhaust gas passes through;
the outer pipe substantially covers an outer circumference of the inner pipe,
a plurality of inner pipe orifices communicate with a volume bounded by the outer pipe and the inner pipe.

10. The exhaust heat recovery muffler as set forth in claim 4, wherein:
the muffler unit further comprises:
an inner pipe wherein the exhaust gas passes through;
the outer pipe substantially covers an outer circumference of the inner pipe,
a plurality of inner pipe orifices communicate with a volume bounded by the outer pipe and the inner pipe.

11. The exhaust heat recovery muffler as set forth in claim 5, wherein:
the muffler unit further comprises:
an inner pipe wherein the exhaust gas passes through;
the outer pipe substantially covers an outer circumference of the inner pipe,
a plurality of inner pipe orifices communicate with a volume bounded by the outer pipe and the inner pipe.

12. The exhaust heat recovery muffler as set forth in claim 1, wherein:
the switching valve switches the flow of exhaust gas between the muffler unit and the exhaust heat recovery unit by blocking and permitting the flow of exhaust gas into the muffler unit.

13. An exhaust heat recovery muffler comprising:
a muffler unit that modifies an exhaust noise and includes an outer pipe, and
an exhaust heat recovery unit that exchanges heat between an exhaust gas and a heat exchange medium and includes:
a substantially cylindrical outer shell,
a substantially cylindrical outer jacket joined to an inner circumference of the outer shell, forming a first volume bounded by the outer jacket and the inner circumference of the outer shell,
a substantially cylindrical inner jacket joined to an outer circumference of the outer pipe, forming a second volume bounded by the inner jacket and the outer circumference of the outer pipe,
an exhaust gas passageway formed between an inner circumference of the outer jacket and an outer circumference of the inner jacket, and
a heat exchange medium passageway formed by at least one of a group consisting of the first volume and the second volume,
a switching valve that switches a flow of the exhaust gas between the muffler unit and the exhaust heat recover unit, wherein:
the exhaust heat recovery unit is integrally disposed with the muffler unit, and
the outer shell covers an outer circumference of the outer pipe.

14. The exhaust heat recovery muffler as set forth in claim 13, wherein:
the exhaust heat recovery unit further comprises:
at least one communication orifice between the first volume and the second volume,
the heat exchange medium passageway further includes the at least one communication orifice, and
at least one of the group consisting of the inner jacket and the outer jacket has a corrugated cross-sectional surface perpendicular to a longitudinal direction thereof.

15. The exhaust heat recovery muffler as set forth in claim 14, wherein;
a corrugation of the inner jacket is recessed inward in repeating geometric shapes, and
a corrugation of the outer jacket is protruding outward in the repeating geometric shapes.

16. The exhaust heat recovery muffler as set forth in claim 15, wherein:
the repeating geometric shapes are semi-circular arcs.

17. The exhaust heat recovery muffler as set forth in claim 15, wherein:
the repeating geometric shapes are rectangles.

18. The exhaust heat recovery muffler as set forth in claim 14, wherein:
the muffler unit further comprises:
an inner pipe wherein the exhaust gas passes through;
the outer pipe substantially covers an outer circumference of the inner pipe,
a plurality of inner pipe orifices communicate with a volume bounded by the outer pipe and the inner pipe.

19. An exhaust heat recovery muffler comprising:
a muffler unit that modifies an exhaust noise and includes:
an outer pipe connected to an inner pipe,
wherein the inner pipe is perforated so as to communicate with the volume bounded by an inner circumference of the outer pipe and an outer circumference of the inner pipe, and
an exhaust heat recovery unit that exchanges heat between an exhaust gas and a heat exchange medium and includes:
a substantially cylindrical outer shell,
a substantially cylindrical outer jacket joined to an inner circumference of the outer shell, forming a first volume bounded by the outer jacket and the inner circumference of the outer shell,
a substantially cylindrical inner jacket joined to an outer circumference of the outer pipe, forming a second volume bounded by the inner jacket and the outer circumference of the outer pipe,
an exhaust gas passageway formed between an inner circumference of the outer jacket and an outer circumference of the inner jacket, and
a heat exchange medium passageway formed by at least one of a group consisting of the first volume and the second volume,
a switching valve that switches a flow of the exhaust gas between the muffler unit and the exhaust heat recover unit, wherein:
the exhaust heat recovery unit is disposed surrounding the outer pipe of the muffler unit.

20. The exhaust heat recovery muffler as set forth in claim 19, wherein:
the exhaust heat recovery unit further comprises:
at least one communication orifice between the first volume and the second volume,
the heat exchange medium passageway further includes the at least one communication orifice, and
the inner jacket has a inner corrugated cross-sectional surface perpendicular to a longitudinal direction thereof,
the outer jacket has an outer corrugated cross-sectional surface perpendicular to a longitudinal direction thereof.
